(19) United States
(12) Patent Application Publication
(10) Pub. No.: US 2025/0157044 A1
(43) Pub. Date: May 15, 2025

(54) INFORMATION PROCESSING METHOD, INFORMATION PROCESSING DEVICE, AND NON-TRANSITORY COMPUTER READABLE RECORDING MEDIUM STORING INFORMATION PROCESSING PROGRAM

(71) Applicant: PANASONIC INTELLECTUAL PROPERTY MANAGEMENT CO., LTD., Osaka (JP)

(72) Inventors: Satoshi MATSUI, Kyoto (JP); Tadamasa TOMA, Osaka (JP); Minami NAKA, Osaka (JP)

(73) Assignee: PANASONIC INTELLECTUAL PROPERTY MANAGEMENT CO., LTD., Osaka (JP)

(21) Appl. No.: 19/025,624

(22) Filed: Jan. 16, 2025

Related U.S. Application Data
(63) Continuation of application No. PCT/JP2023/025796, filed on Jul. 12, 2023.
(60) Provisional application No. 63/368,908, filed on Jul. 20, 2022.
(60) Provisional application No. 63/368,914, filed on Jul. 20, 2022.

(30) Foreign Application Priority Data
Jun. 19, 2023 (JP) 2023-100245

(51) Int. Cl. G06T 7/10; G06T 7/70; G06V 10/25; G06V 10/74

(52) U.S. Cl. CPC G06T 7/10; G06T 7/70; G06V 10/25; G06V 10/761; G06V 2201/07

(57) ABSTRACT

An image processing device acquires an image captured by a camera, recognizes a plurality of markers included in the image, specifies a capturable area surrounded by the plurality of recognized markers when the plurality of markers is recognized, and specifies, as the capturable area, an area in the image acquired this time, the area matching a capturable image in the capturable area previously specified when the plurality of markers is not recognized, creates a mask image that masks an area outside the capturable area in the image, and outputs the mask image.

### FIELD OF INVENTION

The present disclosure relates to a technology to mask areas other than a capturable area in an image.

### BACKGROUND ART

For example, in Patent Literature 1, a capturable area where video sharing with a remote support worker is permitted in a work area is set, and a video control device that transmits a masking video in which the work area other than the capturable area is masked to a remote terminal for the remote support worker is disclosed. A conventional video control device detects markers included in video data, extracts marker information indicating the capturable area from the detected markers, determines a video area determined to be outside the capturable area in the video data as a non-sharable video area, masks the non-sharable video area, and generates a masking video.

However, with the conventional technology mentioned above, if the plurality of markers is not recognized, an image with the masked capturable area surrounded by the plurality of markers is output. This may prevent an on-site worker from receiving support from a worker at a remote location, and further improvement is required.
Patent Literature 1: JP 2021-150866 A

### SUMMARY OF THE INVENTION

The present disclosure has been made to solve the above problem, and an object of the present disclosure is to provide a technology that can output an image in which all areas other than the capturable area surrounded by the plurality of markers are masked even if the plurality of markers is not recognized.

An information processing method according to the present disclosure is an information processing method in a computer, and includes: acquiring an image captured by a camera; recognizing a plurality of markers included in the image; specifying a capturable area surrounded by the plurality of recognized markers when the plurality of markers is recognized, and specifying, as the capturable area, an area in the image acquired this time, the area matching a capturable image in the capturable area previously specified when the plurality of markers is not recognized; creating a mask image that masks an area outside the capturable area in the image; and outputting the mask image.

According to the present disclosure, even if the plurality of markers is not recognized, it is possible to output an image in which all areas other than the capturable area surrounded by the plurality of markers are masked.

### BRIEF DESCRIPTION OF THE DRAWINGS

FIG. 1 is a diagram showing one example of a configuration of a work support system in a first embodiment of the present disclosure.

FIG. 2 is a view showing one example of a work space in the present first embodiment.

FIG. 3 is a diagram showing one example of a configuration of an image processing device in the present first embodiment.

FIG. 4 is a view showing one example of an image captured by a camera such that all markers are visible in the present first embodiment.

FIG. 5 is a view showing one example of an initial capturable image in the present first embodiment.

FIG. 6 is a view showing one example of a mask image created based on the image shown in FIG. 4 in the present first embodiment.

FIG. 7 is a view showing one example of an image captured by the camera that comes close to a support target device in the present first embodiment.

FIG. 8 is a view showing one example of the mask image created based on the image shown in FIG. 7 in the present first embodiment.

FIG. 9 is a view showing one example of an image captured by the camera whose image capturing range moves to the right in the present first embodiment.

FIG. 10 is a view showing one example of the mask image created based on the image shown in FIG. 9 in the present first embodiment.

FIG. 11 is a first flowchart for describing the work support process by the image processing device in the first embodiment of the present disclosure.

FIG. 12 is a second flowchart for describing the work support process by the image processing device in the first embodiment of the present disclosure.

FIG. 13 is a diagram showing one example of a configuration of an image processing device in the present second embodiment.

FIG. 14 is a first flowchart for describing the work support process by the image processing device in the second embodiment of the present disclosure.

FIG. 15 is a second flowchart for describing the work support process by the image processing device in the second embodiment of the present disclosure.

FIG. 16 is a diagram showing one example of a configuration of an image processing device in the present third embodiment.

FIG. 17 is a view showing one example of an image captured by a camera when all of a plurality of markers are first recognized in the present third embodiment.

FIG. 18 is a view showing one example of a mask image created when the camera comes close to a support target device from an initial position in the present third embodiment.

FIG. 19 is a view showing one example of the mask image created when the camera comes close to the support target device from the initial position and a capturing range moves to the right in the present third embodiment.

FIG. 20 is a first flowchart for describing the work support process by the image processing device in the third embodiment of the present disclosure.

FIG. 21 is a second flowchart for describing the work support process by the image processing device in the third embodiment of the present disclosure.

FIG. 22 is a third flowchart for describing the work support process by the image processing device in the third embodiment of the present disclosure.

### DETAILED DESCRIPTION

### (Knowledge Underlying Present Disclosure)

In order for an on-site worker to efficiently receive operational support from a worker at a remote location, it is effective to share a video that captures the on-site situation with the worker at a remote location.

When a video is transmitted to a remote location, there is a possibility that confidential information may be captured on the video. Therefore, to prevent confidential information from being leaked to the outside through video transmission, a process is performed to specify an object that can be transmitted as a video or an object that is confidential information, and to mask an area corresponding to the confidential information in the video.

For example, the on-site worker places a plurality of markers to surround an area where a video may be transmitted, that is, an area that does not include confidential information. The plurality of markers in the captured video is recognized, and an area outside a capturable area surrounded by the plurality of recognized markers is masked, thereby preventing the confidential information from leaking. However, if a camera moves and some or all of the plurality of markers are outside the capturing range of the camera, there is a risk that the capturable area cannot be determined, all pixels of the video are masked, preventing the desired video from being transmitted.

In the above-described conventional technology, each of the plurality of markers is a two-dimensional code having marker information. Therefore, if one or more of the plurality of markers are within the field of view of the camera, the conventional video control device can extract the marker information indicating the capturable area from the one or more detected markers. The conventional video control device can determine the video area that is determined to be outside the capturable area out of the video data as a non-shareable video area, mask the non-shareable video area, and generate a masking video.

However, if all the markers are outside the field of view of the camera, it is difficult for the conventional technology to determine the capturable area. In addition, if the plurality of markers is not a two-dimensional code and some of the plurality of markers are outside the field of view of the camera, it is difficult to determine the capturable area.

To solve the above problems, the following technology is disclosed.

(1) An information processing method according to one aspect of the present disclosure is an information processing method in a computer, and includes: acquiring an image captured by a camera; recognizing a plurality of markers included in the image; specifying a capturable area surrounded by the plurality of recognized markers when the plurality of markers is recognized, and specifying, as the capturable area, an area in the image acquired this time, the area matching a capturable image in the capturable area previously specified when the plurality of markers is not recognized; creating a mask image that masks an area outside the capturable area in the image; and outputting the mask image.

With this configuration, when the plurality of markers included in the image is recognized, the capturable area surrounded by the plurality of recognized markers is specified. On the other hand, when the plurality of markers is not recognized, the area in the image acquired this time is specified as the capturable area, the area matching the capturable image in the previously specified capturable area. Then, the mask image that masks the area outside the capturable area in the image is created, and the mask image is output.

Therefore, even if the plurality of markers is not recognized, it is possible to output the mask image in which all areas other than the capturable area surrounded by the plurality of markers are masked. As a result, the on-site worker can receive efficient work support from the worker at a remote location.

(2) In the information processing method according to (1) described above, creating the mask image may include creating the mask image with all areas in the image masked when the capturable area is not specified.

With this configuration, when the capturable area is not specified, the mask image that makes all areas in the image is created, making it possible to reliably prevent an image including information that should be concealed from being output.

(3) In the information processing method according to (1) or (2) described above, when the plurality of markers is not recognized, specifying the capturable area may include: comparing the image acquired this time with the capturable image in the capturable area specified previously; and specifying the area that matches the capturable image in the image as the capturable area.

With this configuration, when the plurality of markers is not recognized, by performing the matching process of the capturable image in the capturable area specified previously and the image acquired this time, the capturable area in the image acquired this time can be specified.

(4) The information processing method according to (3) described above may further include storing, in a memory, the capturable image in the capturable area in the image as an initial capturable image when the plurality of markers is first recognized, in which specifying the capturable area may include: comparing the initial capturable image with the image acquired this time; and specifying the area that matches the initial capturable image in the image as the capturable area when the plurality of markers is not recognized.

With this configuration, when the plurality of markers is not recognized, by performing the matching process of the initial capturable image obtained when the plurality of markers is first recognized, and the image acquired this time, the capturable area in the image acquired this time can be specified.

(5) The information processing method according to (4) described above may further include: storing a first sensing value representing a position and posture of the camera in the memory as a first initial sensing value when the plurality of markers is first recognized; acquiring the first initial sensing value and the current first sensing value when the capturable area is not specified; and specifying, as the capturable area, an area in the image acquired this time, the area matching the initial capturable image, based on a current position and current posture of the camera with respect to an initial position and initial posture of the camera, the current position and current posture being estimated based on the first initial sensing value and the current first sensing value.

With this configuration, when the area in the image acquired this time is not specified as the capturable area, the area matching the capturable image in the previously specified capturable area, the capturable area in the image acquired this time can be specified based on the current position and current posture of the camera with respect to the initial position and initial posture of the camera.

(6) In the information processing method according to (3) described above, specifying the capturable area may include specifying, as the capturable area, an area in the image acquired this time, the area matching the capturable image in the capturable area specified one frame earlier when the plurality of markers is not recognized.

With this configuration, when the plurality of markers is not recognized, by performing the matching process of the capturable image in the capturable area specified one frame earlier and the image acquired this time, the capturable area in the image acquired this time can be specified.

(7) The information processing method according to (6) described above may further include: comparing the capturable image in the capturable area estimated one frame earlier and stored in a memory with the image of a current frame acquired this time, and estimating an area that matches the capturable image in the image as the capturable area of the current frame; storing the capturable image in the estimated capturable area of the current frame in the memory; and specifying the capturable area includes specifying the estimated capturable area of the current frame as the capturable area when the plurality of markers is not recognized.

With this configuration, since the capturable area is estimated for each frame, if the plurality of markers is not recognized, the estimated capturable area of the current frame can be specified as the capturable area in the image acquired this time.

(8) The information processing method according to (7) described above may further include: acquiring a first sensing value representing a position and posture of the camera for each frame, and storing the acquired first sensing value in the memory; acquiring the first sensing value one frame earlier and the current first sensing value when the capturable area is not specified; and specifying an area in the image acquired this time, the area matching the capturable image one frame earlier, as the capturable area based on a current position and current posture of the camera with respect to the position and posture of the camera one frame earlier, the current position and current posture being estimated based on the first sensing value one frame earlier and the current first sensing value.

With this configuration, when the area in the image acquired this time is not specified as the capturable area, the area matching the capturable image in the previously specified capturable area, the capturable area in the image acquired this time can be specified based on the current position and current posture of the camera with respect to the position and posture of the camera one frame earlier.

(9) The information processing method according to (1) or (2) described above may further include: storing, in a memory, the capturable image in the capturable area in the image of an initial frame as an initial capturable image when the plurality of markers is first recognized; comparing the image one frame earlier with the image of a current frame, and calculating an amount of change between a capturing range of the image one frame earlier and a capturing range of the image of the current frame for each frame; calculating a cumulative value of the amount of change from the initial frame to the current frame; and specifying the capturable area includes specifying the capturable area of the current frame based on the initial capturable area and the cumulative value when the plurality of markers is not recognized.

With this configuration, based on the change in the capturing range of the image from the initial frame to the current frame and the initial capturable image in the image of the initial frame, the capturable area of the current frame can be specified.

(10) The information processing method according to (1) or (2) described above may further include: storing, in a memory, the capturable image in the capturable area in the image as an initial capturable image when the plurality of markers is first recognized; storing, in the memory, each distance from the camera to an object for each pixel in the initial capturable image as a second initial sensing value when the plurality of markers is first recognized; acquiring the second initial sensing value and a second sensing value representing the distance from the camera to the object for each pixel in the image acquired this time when the capturable area is not specified; and specifying, as the capturable area, an area where the second sensing value of the plurality of pixels in the image acquired this time is equal to or less than a longest distance of the second initial sensing value.

With this configuration, in the image acquired this time, an object located farther than an object in the initial capturable image is masked, making it possible to easily prevent an image including information that should be concealed from being output.

Furthermore, the present disclosure can be implemented not only as an information processing method for executing the characteristic processing as described above, but also as an information processing device or the like having a characteristic configuration corresponding to the characteristic processing executed by the information processing method. Furthermore, the present disclosure can also be implemented as a computer program that causes a computer to execute the characteristic processing included in the information processing method described above. Therefore, other aspects below can also achieve an effect as in the above information processing method.

(11) An information processing device according to another aspect of the present disclosure includes: an acquisition part that acquires an image captured by a camera; a recognition part that recognizes a plurality of markers included in the image; a specification part that specifies a capturable area surrounded by the plurality of recognized markers when the plurality of markers is recognized, and specifies, as the capturable area, an area in the image acquired this time, the area matching a capturable image in the capturable area previously specified when the plurality of markers is not recognized; a creation part that creates a mask image that masks an area outside the capturable area in the image; and an output part that outputs the mask image.

(12) An information processing program according to another aspect of the present disclosure causes a computer to execute functions of: acquiring an image captured by a camera; recognizing a plurality of markers included in the image; specifying a capturable area surrounded by the plurality of recognized markers when the plurality of markers is recognized, and specifying, as the capturable area, an area in the image acquired this time, the area matching a capturable image in the capturable area previously specified when the plurality of markers is not recognized; creating a mask image that masks an area outside the capturable area in the image; and outputting the mask image.

(13) A non-transitory computer-readable recording medium according to another aspect of the present disclosure stores an information processing program. The information processing program causes a computer to execute functions of: acquiring an image captured by a camera; recognizing a plurality of markers included in the image; specifying a capturable area surrounded by the plurality of recognized markers when the plurality of markers is recognized, and specifying, as the capturable area, an area in the image acquired this time, the area matching a capturable image in the capturable area previously specified when the plurality of markers is not recognized; creating a mask image that masks an area outside the capturable area in the image; and outputting the mask image.

Embodiments of the present disclosure will be described below with reference to the accompanying drawings. Note that each of the embodiments to be described below shows one specific example of the present disclosure. Numerical values, shapes, components, steps, an order of steps, and the like shown in the embodiments below are one example, and are not intended to limit the present disclosure. Furthermore, a component that is not described in an independent claim representing the highest concept among components in the embodiments below will be described as an arbitrary component. In all the embodiments, respective contents can be combined.

### First Embodiment

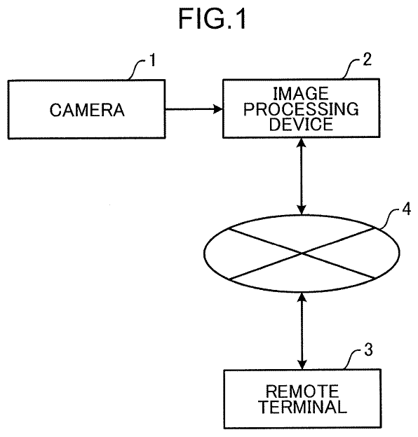

FIG. 1 is a diagram showing one example of a configuration of a work support system in a first embodiment of the present disclosure. The work support system shown in FIG. 1 includes a camera 1, an image processing device 2, and a remote terminal 3.

The camera 1 is, for example, a wearable camera that is worn on the head of an on-site worker. The worker performs work while wearing the camera 1. At this time, the on-site worker receives operational support from a worker at a remote location while capturing a support target device in the on-site work space with the camera 1. The worker at a remote location supports operations, repairs, and the like of the support target device while looking at images transmitted from the site.

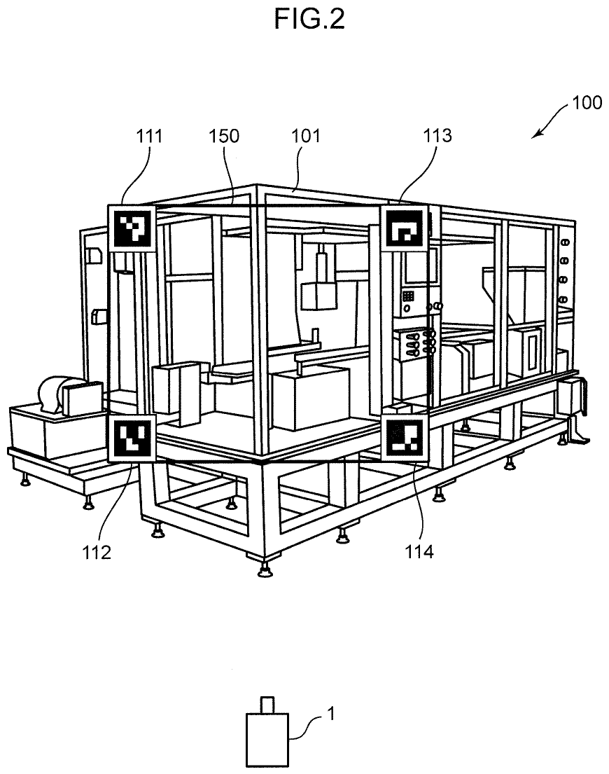

FIG. 2 is a view showing one example of the work space in the present first embodiment.

As shown in FIG. 2, a support target device 101 is installed in a work space 100. The on-site worker uses the camera 1 to capture an image of the support target device 101. The image captured by the camera 1 is transmitted to the remote terminal 3 operated by the worker at a remote location. At this time, there is a possibility that confidential information will appear in the captured image. Therefore, to prevent images including confidential information from being transmitted, areas other than a specific work area are hidden by image processing (masking process). The on-site worker attaches a plurality of markers 111, 112, 113, and 114 to surround the work area that does not include confidential information on the support target device 101. The plurality of markers 111, 112, 113, and 114 is directly attached to surround the capturable work area, for example, using an adhesive substance or a magnet.

The camera 1 transmits the captured image to the image processing device 2 via short-distance wireless communication. The camera 1 transmits the image at a predetermined frame rate to the image processing device 2. Therefore, moving images are transmitted from the camera 1 to the image processing device 2. Note that the camera 1 is wirelessly connected to the image processing device 2, but may be connected to the image processing device 2 via wired connection.

Note that the camera 1 may be a terminal with a camera, such as a smartphone or a tablet computer. The camera 1 may also be a digital camera.

The image processing device 2 is, for example, a personal computer operated by the on-site worker. The image processing device 2 is connected to the remote terminal 3 via a network 4 to allow communication with each other. The network 4 is, for example, the Internet.

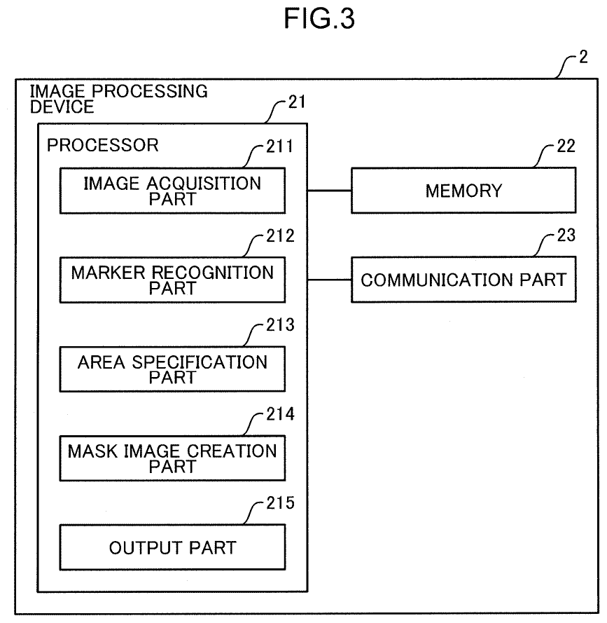

FIG. 3 is a diagram showing one example of a configuration of the image processing device 2 in the present first embodiment.

The image processing device 2 shown in FIG. 3 includes a processor 21, a memory 22, and a communication part 23.

The processor 21 is, for example, a central processing unit (CPU). An image acquisition part 211, a marker recognition part 212, an area specification part 213, a mask image creation part 214, and an output part 215 are implemented by the processor 21.

The memory 22 is, for example, a storage device that can store various types of information, such as a random access memory (RAM), a hard disk drive (HDD), a solid state drive (SSD), or a flash memory.

Note that the image processing device 2 corresponds to one example of the information processing device, the image acquisition part 211 corresponds to one example of the acquisition part, the marker recognition part 212 corresponds to one example of the recognition part, the area specification part 213 corresponds to one example of the specification part, the mask image creation part 214 corresponds to one example of the creation part, and the output part 215 corresponds to one example of the output part.

The communication part 23 receives the image transmitted by the camera 1. The communication part 23 outputs the received image to the processor 21. The communication part 23 receives the moving image transmitted at a predetermined frame rate, and outputs the image to the processor 21 for each frame.

The image acquisition part 211 acquires the image captured by the camera 1. The image acquisition part 211 acquires the image for each frame.

The marker recognition part 212 recognizes a plurality of markers included in the image acquired by the image acquisition part 211. In the present first embodiment, four different types of markers 111, 112, 113, and 114 are used. As shown in FIG. 2, the four markers 111, 112, 113, and 114 are rectangular and have patterns different from each other.

The on-site worker attaches the marker 111 to the upper left of a capturable work area 150, attaches the marker 112 to the lower left of the capturable work area 150, attaches the marker 113 to the upper right of the capturable work area 150, and attaches the marker 114 to the lower right of the capturable work area 150. Note that locations at which the four markers 111, 112, 113, and 114 are placed are not particularly determined. The four markers 111, 112, 113, and 114 may be placed at any of the upper left, lower left, upper right, and lower right of the capturable work area 150.

The marker recognition part 212 recognizes the four markers 111, 112, 113, and 114 included in the image by pattern matching. That is, the marker recognition part 212 recognizes the four markers 111, 112, 113, and 114 in the image by comparing the patterns of the plurality of markers stored in advance in the memory 22 with the patterns of the four markers 111, 112, 113, and 114 included in the image.

Note that the marker recognition part 212 can recognize not only markers captured from the front but also markers captured from diagonal directions.

In the present first embodiment, the four markers are used, but the present disclosure is not limited to this example and three markers or five or more markers may be used.

When the plurality of markers 111, 112, 113, and 114 is recognized by the marker recognition part 212, the area specification part 213 specifies the capturable area surrounded by the recognized plurality of markers 111, 112, 113, and 114. On the other hand, when the plurality of markers 111, 112, 113, and 114 is not recognized by the marker recognition part 212, the area specification part 213 specifies, as the capturable area, the area in the image acquired this time, the area matching the capturable image in the capturable area specified previously.

That is, when all of the plurality of markers 111, 112, 113, and 114 are recognized, the area specification part 213 specifies the capturable area surrounded by the plurality of recognized markers 111, 112, 113, and 114. Meanwhile, when at least one of the plurality of markers 111, 112, 113, and 114 is not recognized, the area specification part 213 specifies, as the capturable area, the area in the image acquired this time, the area matching the capturable image in the capturable area specified previously.

When the four markers 111, 112, 113, and 114 are recognized, the area specification part 213 specifies the capturable area obtained by connecting the upper left vertex of the upper left marker 111, the lower left vertex of the lower left marker 112, the upper right vertex of the upper right marker 113, and the lower right vertex of the lower right marker 114 with a straight line.

Note that when the four markers 111, 112, 113, and 114 are recognized, the area specification part 213 may specify the capturable area obtained by connecting the lower right vertex of the upper left marker 111, the upper right vertex of the lower left marker 112, the lower left vertex of the upper right marker 113, and the upper left vertex of the lower right marker 114 with a straight line. When the four markers 111, 112, 113, and 114 are recognized, the area specification part 213 may specify the capturable area obtained by connecting center points of respective four markers 111, 112, 113, and 114 with a straight line.

Note that even when one of the four markers is not recognized, the area specification part 213 may predict the location of one unrecognized marker and specify the capturable area surrounded by the four markers.

Meanwhile, when the plurality of markers is not recognized, the area specification part 213 compares the image acquired this time with the capturable image in the capturable area specified previously, and specifies the area that matches the capturable image in the image as the capturable area.

More specifically, when the plurality of markers is first recognized, the area specification part 213 stores the capturable image in the capturable area in the image as the initial capturable image in the memory 22. Then, when the plurality of markers is not recognized, the area specification part 213 compares the image acquired this time with the initial capturable image, and specifies the area that matches the initial capturable image in the image as the capturable area. At this time, the area specification part 213 extracts a plurality of feature points of the initial capturable image and extracts a plurality of feature points of the image acquired this time, associates the plurality of feature points of the initial capturable image with the plurality of feature points of the image acquired this time, and specifies an area that has feature points identical to the plurality of feature points of the initial capturable image in the image as the capturable area.

The mask image creation part 214 creates a mask image that masks the area outside of the capturable area specified by the area specification part 213 in the image. When the capturable area is not specified by the area specification part 213, the mask image creation part 214 may create the mask image that masks all areas in the image.

The memory 22 stores the initial capturable image specified when the plurality of markers is first recognized.

The output part 215 outputs the mask image created by the mask image creation part 214. The output part 215 outputs the mask image to the communication part 23. The communication part 23 transmits the mask image to the remote terminal 3.

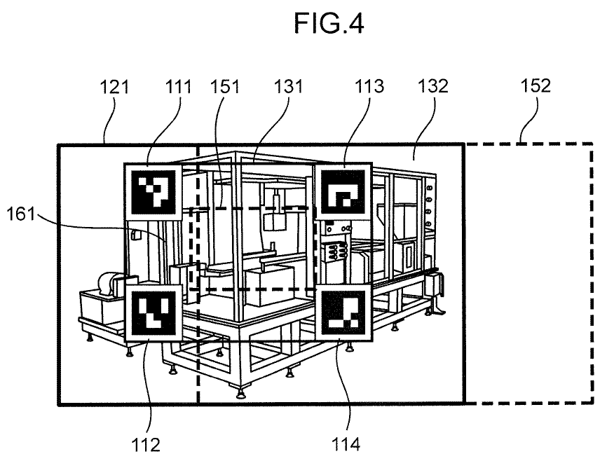

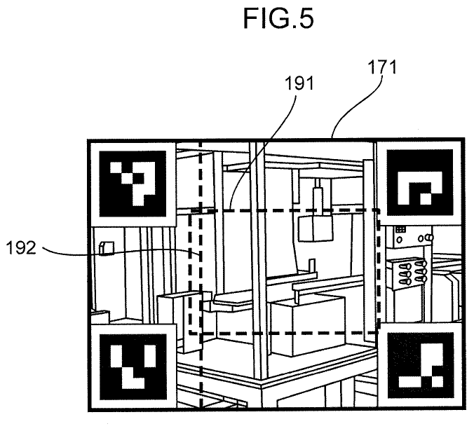

FIG. 4 is a view showing one example of an image 121 captured by the camera 1 such that all the markers appear in the present first embodiment. FIG. 5 is a view showing one example of an initial capturable image 171 in the present first embodiment. Note that in FIG. 4, the markers are illustrated larger than the actual markers for ease of understanding the description.

The image 121 includes all the four markers 111, 112, 113, and 114. The marker recognition part 212 recognizes the four markers 111, 112, 113, and 114 included in the image 121 acquired by the image acquisition part 211. When all the four markers 111, 112, 113, and 114 are recognized, the area specification part 213 specifies a capturable area 131 surrounded by the four recognized markers 111, 112, 113, and 114. When the four markers 111, 112, 113, and 114 are first recognized, the area specification part 213 stores a capturable image 161 in the capturable area 131 in the image 121 as the initial capturable image 171 in the memory 22.

As shown in FIG. 5, the initial capturable image 171 is an image obtained when all the four markers 111, 112, 113, and 114 are first recognized, and is an image surrounded by the four markers 111, 112, 113, and 114 in the capturable area 131.

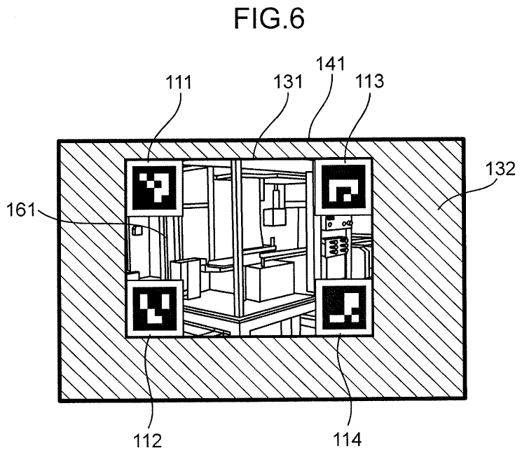

FIG. 6 is a view showing one example of a mask image 141 created based on the image 121 shown in FIG. 4 in the present first embodiment.

The mask image creation part 214 creates the mask image 141 that masks an area 132 outside the capturable area 131 in the image 121. The mask image creation part 214 performs the masking process on the area 132 outside the capturable area 131 in the image 121. The masking process may be, for example, the process of painting the area 132 with a predetermined color such as black, white, or gray, the process of applying a blurring process to the area 132, or the process of applying a mosaic process to the area 132. In the mask image 141 shown in FIG. 6, the capturable image 161 in the capturable area 131 is visible, whereas the area 132 other than the capturable area 131 is concealed.

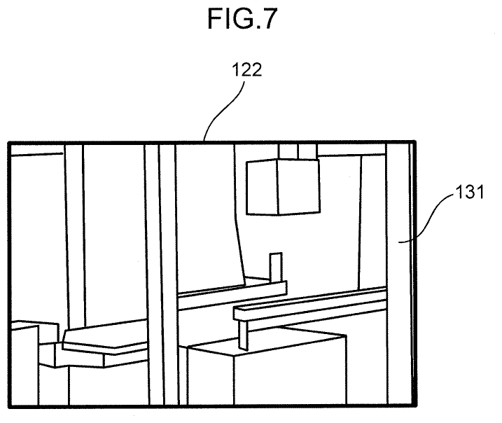

FIG. 7 is a view showing one example of an image 122 captured by the camera 1 that comes close to the support target device 101 in the present first embodiment.

When the camera 1 comes close to the support target device 101, the capturing range of the camera 1 changes to an area 151 in FIG. 4. In this case, the four markers 111, 112, 113, and 114 are no longer included in the image 122. The image 122 does not include the four markers 111, 112, 113, and 114. Therefore, the marker recognition part 212 does not recognize the markers in the image 122 acquired by the image acquisition part 211. When at least one of the four markers 111, 112, 113, and 114 is not recognized, the area specification part 213 compares the image 122 acquired this time with the initial capturable image 171, and specifies the area that matches the initial capturable image 171 in the image 122 as the capturable area. In FIG. 7, since the camera 1 comes close to the support target device 101, the four markers 111, 112, 113, and 114 are not included in the image 122. However, the image 122 acquired this time matches an area 191 of the initial capturable image 171 shown in FIG. 5. Therefore, the area specification part 213 specifies the entire image 122 acquired this time as the capturable area 131.

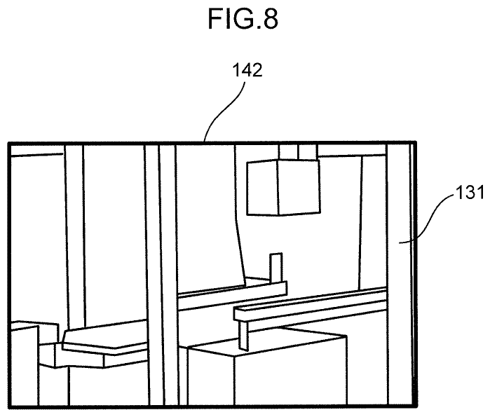

FIG. 8 is a view showing one example of a mask image 142 created based on the image 122 shown in FIG. 7 in the present first embodiment.

The mask image creation part 214 creates the mask image 142 that masks the area 132 outside the capturable area 131 in the image 122. In the mask image 142 shown in FIG. 8, since the entire image 122 acquired this time is the capturable area 131, the entire mask image 142 is visible.

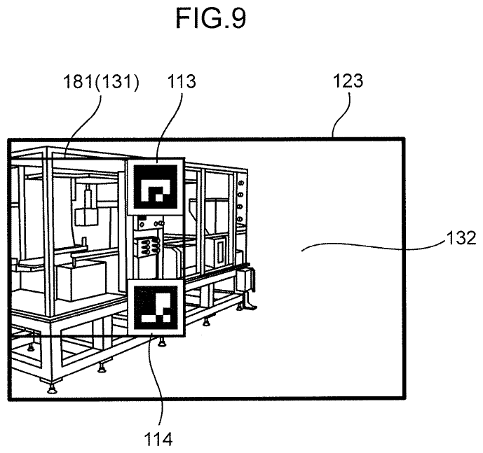

FIG. 9 is a view showing one example of an image 123 captured by the camera 1 whose image capturing range moves to the right in the present first embodiment.

When the capturing range of the camera 1 moves to the right, the capturing range of the camera 1 changes to an area 152 in FIG. 4. In this case, out of the four markers 111, 112, 113, and 114, the two markers 111 and 112 are no longer included in the image 122. The image 123 does not include the two markers 111 and 112 out of the four markers 111, 112, 113, and 114. Therefore, the marker recognition part 212 recognizes the two markers 113 and 114 included in the image 123 acquired by the image acquisition part 211, and does not recognize the two markers 111 and 112 that are not included in the image 123. When at least one of the four markers 111, 112, 113, and 114 is not recognized, the area specification part 213 compares the image 123 acquired this time with the initial capturable image 171, and specifies an area 181 that matches the initial capturable image 171 in the image 123 as the capturable area 131. In FIG. 9, since the capturing range of the camera 1 moves to the right, the two markers 111 and 112 are not included in the image 123. However, the area 181 in the image 123 acquired this time matches an area 192 of the initial capturable image 171 shown in FIG. 5. Therefore, the area specification part 213 specifies the area 181 that matches the initial capturable image 171 in the image 123 as the capturable area 131.

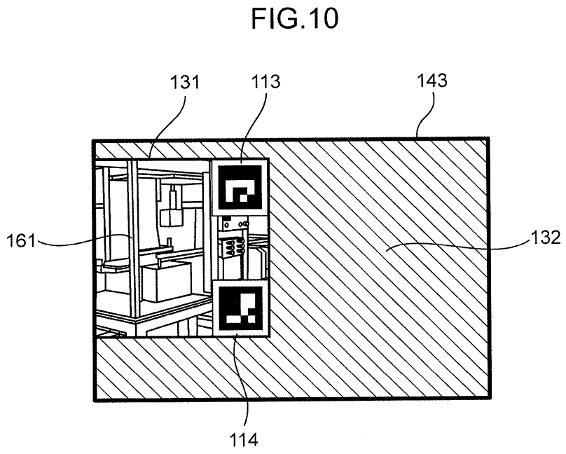

FIG. 10 is a view showing one example of a mask image 143 created based on the image 123 shown in FIG. 9 in the present first embodiment.

The mask image creation part 214 creates the mask image 143 that masks the area 132 outside the capturable area 131 in the image 123. The mask image creation part 214 performs the masking process on the area 132 outside the capturable area 131 in the image 123. In the mask image 143 shown in FIG. 10, the capturable image 161 in the capturable area 131 is visible, whereas the area 132 other than the capturable area 131 is concealed.

As shown in FIG. 10, even if some of the four markers 111, 112, 113, and 114 are not recognized, instead of masking the entire image 123 acquired, the mask image 143 that does not mask the interior of the capturable area 131 can be created.

Note that in the present first embodiment, the image processing device 2 is disposed on-site, but the present disclosure is not limited to this example. The image processing device 2 may be a server provided on the cloud. In this case, the image processing device 2 is connected to the camera 1 via the network 4 to allow communication with each other.

The remote terminal 3 is, for example, a personal computer, a smartphone, or a tablet computer operated by the worker at a remote location. The remote terminal 3 receives the mask image transmitted by the image processing device 2. The remote terminal 3 displays the received mask image. The image processing device 2 transmits the mask image at a predetermined frame rate to the remote terminal 3. Therefore, the moving image is transmitted from the image processing device 2 to the remote terminal 3.

The worker at a remote location can support the work of the on-site worker while looking at the mask image displayed on the remote terminal 3. Note that the image processing device 2 and the remote terminal 3 may transmit and receive not only image data but also voice data to and from each other.

Subsequently, the work support process by the image processing device 2 according to the first embodiment of the present disclosure will be described.

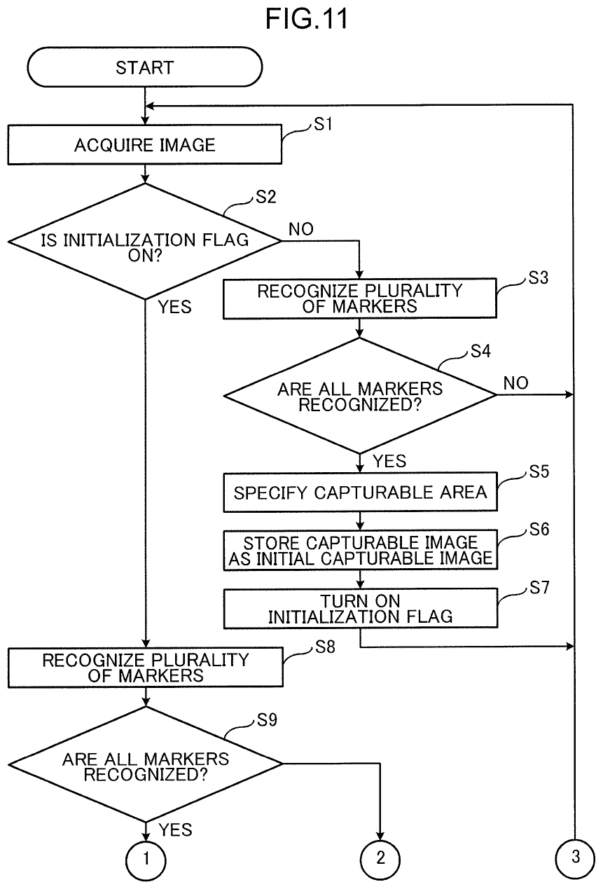

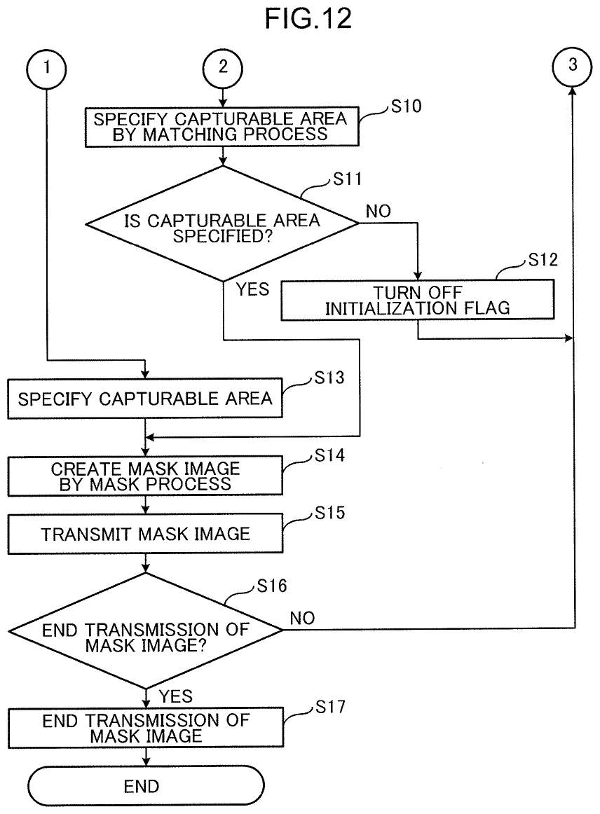

FIG. 11 is a first flowchart for describing the work support process by the image processing device 2 in the first embodiment of the present disclosure. FIG. 12 is a second flowchart for describing the work support process by the image processing device 2 in the first embodiment of the present disclosure.

First, in step S1, the image acquisition part 211 acquires an image captured by the camera 1. Note that when the power of the camera 1 is turned on, or when a button provided in the image processing device 2 for starting transmission of the mask image is pressed, the image is acquired from the camera 1.

Next, in step S2, the marker recognition part 212 determines whether an initialization flag stored in the memory 22 is on. Here, when it is determined that the initialization flag is not on, that is, the initialization flag is off (NO in step S2), in step S3, the marker recognition part 212 recognizes a plurality of markers included in the image acquired by the image acquisition part 211.

Next, in step S4, the area specification part 213 determines whether all the markers are recognized by the marker recognition part 212. Note that the number of plurality of markers used in image recognition is determined in advance. The memory 22 stores in advance the number of plurality of markers. In the present first embodiment, the number of plurality of markers is four. The area specification part 213 determines whether four markers are recognized by the marker recognition part 212.

Here, when it is determined that all the markers are not recognized, that is, when it is determined that at least one of the plurality of markers is not recognized (NO in step S4), the process returns to step S1.

On the other hand, when it is determined that all the markers are recognized (YES in step S4), in step S5, the area specification part 213 specifies the capturable area surrounded by the plurality of markers recognized by the marker recognition part 212.

Next, in step S6, the area specification part 213 stores the capturable image in the capturable area in the image as the initial capturable image in the memory 22.

Next, in step S7, the area specification part 213 turns on the initialization flag stored in the memory 22. After the initialization flag is turned on, the process returns to step S1.

On the other hand, when it is determined that the initialization flag is on (YES in step S2), in step S8, the marker recognition part 212 recognizes the plurality of markers included in the image acquired by the image acquisition part 211.

Next, in step S9, the area specification part 213 determines whether all the markers are recognized by the marker recognition part 212.

Here, when it is determined that all the markers are not recognized, that is, when it is determined that at least one of the plurality of markers is not recognized (NO in step S9), in step S10, the area specification part 213 specifies the capturable area by the matching process on the initial capturable image and the image acquired this time. That is, the area specification part 213 compares the image acquired this time with the initial capturable image, and specifies the area that matches the initial capturable image in the image as the capturable area. Note that if there is no area that matches the initial capturable image in the image, the area specification part 213 does not specify the capturable area.

Next, in step S11, the area specification part 213 determines whether the capturable area is specified. Here, when it is determined that the capturable area is specified (YES in step S11), the process proceeds to step S14.

On the other hand, when it is determined that the capturable area is not specified (NO in step S11), in step S12, the area specification part 213 turns off the initialization flag stored in the memory 22. After the initialization flag is turned off, the process returns to step S1.

On the other hand, when it is determined that all the markers are recognized (YES in step S9), in step S13, the area specification part 213 specifies the capturable area surrounded by the plurality of markers recognized by the marker recognition part 212.

Next, in step S14, the mask image creation part 214 creates the mask image by the masking process to mask the area outside the capturable area specified by the area specification part 213 in the image.

Next, in step S15, the output part 215 transmits the mask image created by the mask image creation part 214 to the remote terminal 3 via the communication part 23. The remote terminal 3 receives the mask image transmitted by the image processing device 2. The remote terminal 3 displays the received mask image.

Next, in step S16, the output part 215 determines whether to end the transmission of the mask image. Note that when the power of the camera 1 is turned off, or when a button provided in the image processing device 2 for ending the transmission of the mask image is pressed, the transmission of the mask image ends.

Here, when it is determined to end the transmission of the mask image (YES in step S16), in step S17, the output part 215 ends the transmission of the mask image.

On the other hand, when it is determined not to end the transmission of the mask image (NO in step S16), the process returns to step S1.

In this manner, when the plurality of markers included in the image is recognized, the capturable area surrounded by the plurality of recognized markers is specified. On the other hand, when the plurality of markers is not recognized, the area in the image acquired this time is specified as the capturable area, the area matching the capturable image in the previously specified capturable area. Then, the mask image that masks the area outside the capturable area in the image is created, and the mask image is output.

Therefore, even if the plurality of markers is not recognized, it is possible to output the mask image in which all areas other than the capturable area surrounded by the plurality of markers are masked. As a result, the on-site worker can receive efficient work support from the worker at a remote location.

### Second Embodiment

In the above-described first embodiment, when the plurality of markers is first recognized, the capturable image in the capturable area in the image is stored in the memory 22 as the initial capturable image. From then on, if the plurality of markers is not recognized from the acquired image, the image acquired this time is compared with the initial capturable image, and the area that matches the initial capturable image in the image is specified as the capturable area.

In contrast, in the second embodiment, when a plurality of markers is first recognized, a capturable image in a capturable area in an image is stored in a memory 22 as an initial capturable image. From then on, the capturable image in the image one frame earlier is compared with the image acquired this time for each frame, and the area that matches the capturable image one frame earlier in the image is estimated as the capturable area. Then, when the plurality of markers is not recognized from the acquired image, the estimated capturable area is specified as the capturable area of the acquired image.

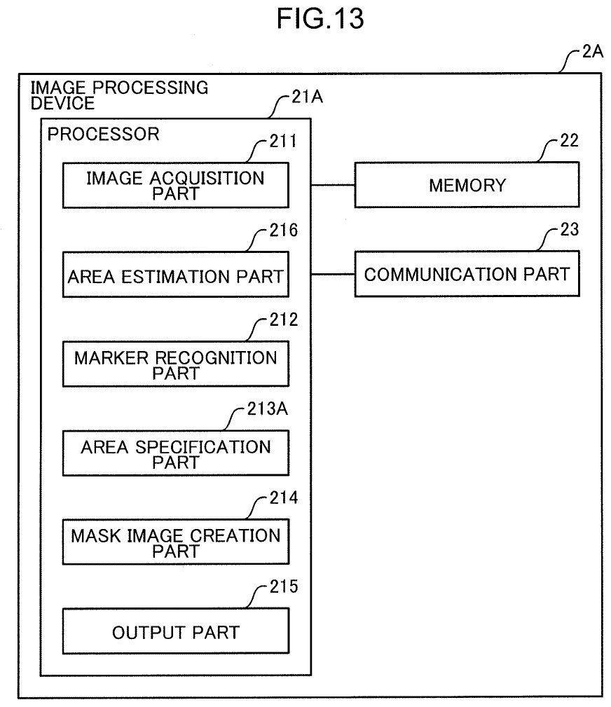

FIG. 13 is a diagram showing one example of a configuration of an image processing device 2A in the present second embodiment. Note that in the present second embodiment, the configuration of the work support system other than the image processing device 2A is the same as the configuration of the work support system in the first embodiment.

The image processing device 2A shown in FIG. 13 includes a processor 21A, the memory 22, and a communication part 23. Note that in the present second embodiment, the same configuration as in the first embodiment will be denoted with the same reference sign, and descriptions thereof will be omitted.

An image acquisition part 211, a marker recognition part 212, an area specification part 213A, a mask image creation part 214, an output part 215, and an area estimation part 216 are implemented by the processor 21A.

The area estimation part 216 compares the capturable image in the capturable area estimated one frame earlier, the capturable image being stored in the memory 22, with the image of the current frame acquired this time, and estimates the area that matches the capturable image in the image as the capturable area of the current frame. The area estimation part 216 estimates the capturable area in the image of the current frame for each frame. The area estimation part 216 stores the capturable image in the estimated capturable area of the current frame in the memory 22.

The memory 22 stores the capturable image estimated from the image one frame earlier and the capturable image estimated from the image of the current frame.

When the plurality of markers is not recognized, the area specification part 213A specifies the area in the image acquired this time, the area matching the capturable image in the capturable area specified one frame earlier, as the capturable area. When the plurality of markers is not recognized, the area specification part 213A specifies the capturable area based on the capturable area of the current frame, the capturable area being estimated by the area estimation part 216.

Subsequently, the work support process by the image processing device 2A in the second embodiment of the present disclosure will be described.

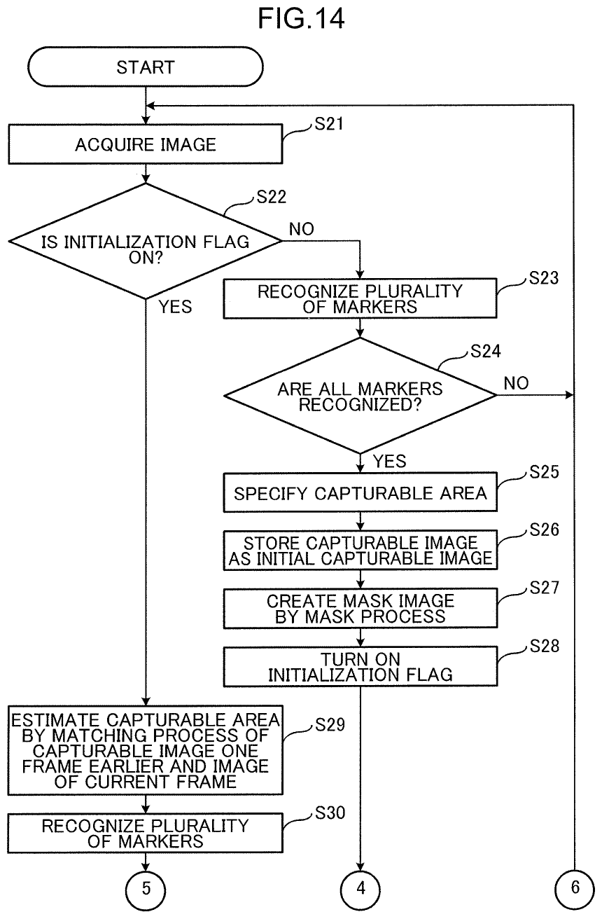

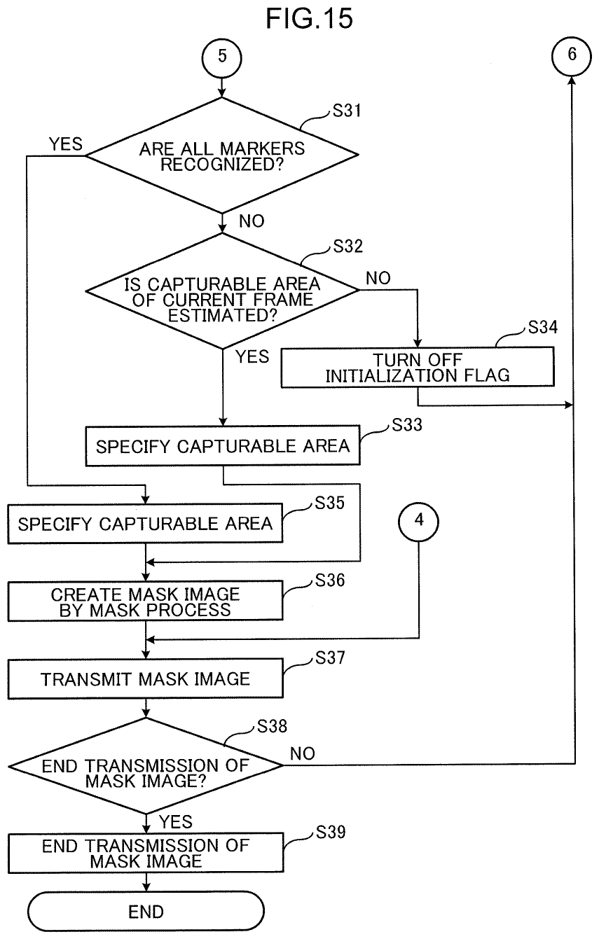

FIG. 14 is a first flowchart for describing the work support process by the image processing device 2A in the second embodiment of the present disclosure. FIG. 15 is a second flowchart for describing the work support process by the image processing device 2A in the second embodiment of the present disclosure.

The processing in steps S21 to S26 is identical to the processing in steps S1 to S6 shown in FIG. 11, and thus description thereof will be omitted.

Next, in step S27, the mask image creation part 214 creates the mask image by the masking process to mask the area outside the capturable area specified by the area specification part 213A in the image.

Next, in step S28, the area specification part 213A turns on the initialization flag stored in the memory 22. After the initialization flag is turned on, the process proceeds to step S37.

On the other hand, when it is determined that the initialization flag is on (YES in step S22), in step S29, the area specification part 213A estimates the capturable area by the matching process of the capturable image estimated one frame earlier and stored in the memory 22, and the image of the current frame acquired this time. That is, the area specification part 213A compares the capturable image one frame earlier with the image of the current frame acquired this time, and estimates the area in the image of the current frame, the area matching the capturable image one frame earlier, as the capturable area. Note that when there is no area that matches the capturable image one frame earlier in the image of the current frame, the area specification part 213A does not estimate the capturable area.

Note that when the current frame is the next frame of the image in which all the markers are first recognized, the area estimation part 216 compares the initial capturable image stored in the memory 22 with the image of the current frame acquired this time, and estimates the area that matches the initial capturable image in the image of the current frame as the capturable area of the current frame. From then on, the area estimation part 216 performs the matching process of the capturable image one frame earlier and the image of the current frame for each frame, and estimates the area that matches the capturable image one frame earlier in the image of the current frame as the capturable area of the current frame.

Upon estimation of the capturable area of the current frame, the area estimation part 216 stores the capturable image in the estimated capturable area of the current frame in the memory 22.

Next, in step S30, the marker recognition part 212 recognizes a plurality of markers included in the image acquired by the image acquisition part 211.

Next, in step S31, the area specification part 213A determines whether all the markers are recognized by the marker recognition part 212.

Here, when it is determined that all the markers are not recognized, that is, when it is determined that at least one of the plurality of markers is not recognized (NO in step S31), in step S32, the area specification part 213A determines whether the capturable area of the current frame is estimated by the area estimation part 216. Note that when the capturable image of the current frame is stored in the memory 22, the area specification part 213A may determine that the capturable area of the current frame is estimated. When the capturable image of the current frame is not stored in the memory 22, the area specification part 213A may determine that the capturable area of the current frame is not estimated.

Here, when it is determined the capturable area of the current frame is estimated (YES in step S32), in step S33, the area specification part 213A specifies the capturable area based on the capturable area of the current frame estimated by the area estimation part 216. That is, the area specification part 213A specifies the capturable area of the current frame estimated by the area estimation part 216 as the capturable area in the image acquired this time.

On the other hand, when it is determined that the capturable area of the current frame is not estimated (NO in step S32), in step S34, the area specification part 213A turns off the initialization flag stored in the memory 22. After the initialization flag is turned off, the process returns to step S21.

On the other hand, when it is determined that all the markers are recognized (YES in step S31), in step S35, the area specification part 213A specifies the capturable area surrounded by the plurality of markers recognized by the marker recognition part 212.

The processing in steps S36 to S39 is identical to the processing in steps S14 to S17 shown in FIG. 12, and thus description thereof will be omitted.

As in the first embodiment, in the matching process of the initial capturable image when the plurality of markers is first recognized and the image of the current frame, when the movement amount of a camera 1 from the initial position is large, the matching process may be difficult, and the accuracy of specifying the capturable area may decrease.

In contrast, in the present second embodiment, for each frame, the matching process of the capturable image in the capturable area one frame earlier and the image of the current frame is performed, improving the accuracy of specifying the capturable area.

Note that in the present second embodiment, when the plurality of markers is first recognized, the area specification part 213A may store the capturable image in the capturable area in the image of an initial frame as the initial capturable image in the memory 22. The area specification part 213A may compare the image one frame earlier with the image of the current frame, and calculate the amount of change between the capturing range of the image one frame earlier and the capturing range of the image of the current frame for each frame. Note that the amount of change indicates, for example, the direction and amount of movement of the capturing range of the current frame with respect to the capturing range one frame earlier. In addition, the area specification part 213A may calculate a cumulative value of the amount of change from the initial frame to the current frame. The cumulative value is stored in the memory 22. When the plurality of markers is not recognized, the area specification part 213A may specify the capturable area of the current frame based on the initial capturable area and the cumulative value.

In this case, the amount of change in the capturing range of the image from the initial frame to the current frame can be determined from the cumulative value. Therefore, based on the initial capturable area in the image of the initial frame and the cumulative value, the capturable area in the image of the current frame can be specified.

### Third Embodiment

In the third embodiment, a first sensing value representing the position and posture of a camera 1 is acquired. When a capturable area is not specified by the matching process of an initial capturable image and an image acquired this time, or when the capturable area of the current frame is not specified by the matching process of the capturable image for each frame and the image of the current frame acquired this time, the capturable area is specified by using the acquired first sensing value.

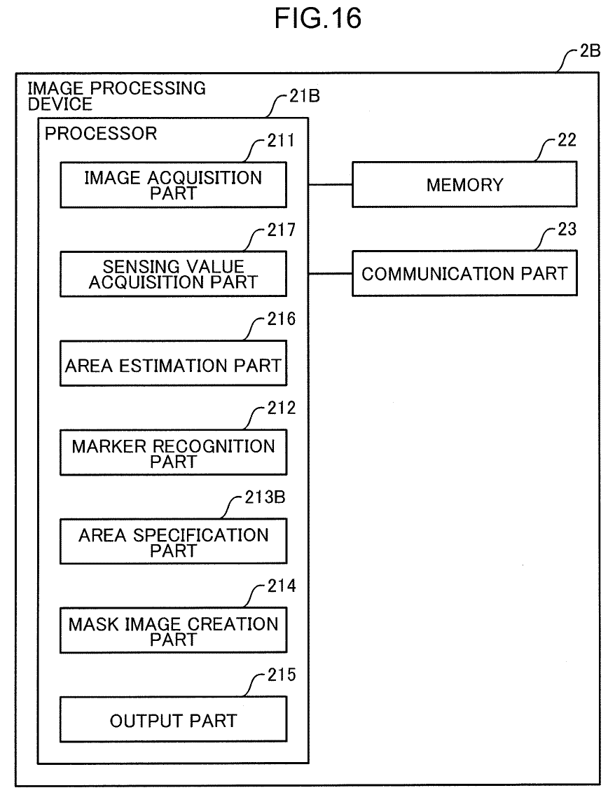

FIG. 16 is a diagram showing one example of a configuration of an image processing device 2B in the present third embodiment. Note that in the present third embodiment, the configuration of the work support system other than the camera 1 and the image processing device 2B is the same as the configuration of the work support system in the first embodiment.

The camera 1 further includes a first sensor that detects the position and posture of the camera 1. The first sensor is, for example, an acceleration sensor and a gyro sensor, and detects the translational movement (x, y, z) and the rotational movement (roll angle, pitch angle, yaw angle) in three axial directions of the camera 1. The camera 1 transmits an image to an image processing device 2B, and transmits the first sensing value representing the position and posture of the camera 1 detected by the first sensor to the image processing device 2B.

The image processing device 2B shown in FIG. 16 includes a processor 21B, a memory 22, and a communication part 23. Note that in the present third embodiment, the same configurations as in the first embodiment and the second embodiment are denoted with the same reference signs, and description thereof will be omitted.

An image acquisition part 211, a marker recognition part 212, an area specification part 213B, a mask image creation part 214, an output part 215, an area estimation part 216, and a sensing value acquisition part 217 are implemented by the processor 21B.

The communication part 23 receives the image and the first sensing value transmitted by the camera 1. The communication part 23 outputs the received image and the first sensing value to the processor 21B. The communication part 23 receives a moving image transmitted at a predetermined frame rate and the first sensing value transmitted at a predetermined sampling period, and outputs the image for each frame and the first sensing value for each sampling to the processor 21B.

The sensing value acquisition part 217 acquires the first sensing value representing the position and posture of the camera 1 for each frame. In general, the sampling period of a sensor such as a gyro sensor is higher than the frame rate of an image, and changes in high-frequency waves can be detected by acquiring the sensing value at a high sampling period. Therefore, the first sensor acquires the first sensing value at the highest possible sampling period and performs signal processing. Examples of signal processing of a gyro sensor include the process for removing drift noise, the process for integrating angular velocity for conversion into an angle, and the like. Then, the sensing value acquisition part 217 acquires the first sensing value that matches or is closest in time to the image frame.

When a plurality of markers is not recognized, the area specification part 213B specifies the area in the image acquired this time, the area matching the capturable image in the capturable area specified one frame earlier, as the capturable area. When the plurality of markers is not recognized, the area specification part 213B specifies the capturable area based on the capturable area of the current frame estimated by the area estimation part 216.

When the plurality of markers is first recognized, the area specification part 213B stores in the memory 22 the capturable image in the capturable area in the image as the initial capturable image, and stores in the memory 22 the first sensing value representing the position and posture of the camera 1 as a first initial sensing value. Then, when the plurality of markers is not recognized, the area specification part 213B compares the image acquired this time with the initial capturable image, and specifies the area that matches the initial capturable image in the image as the capturable area.

When the capturable area is not specified based on the capturable area of the current frame estimated by the area estimation part 216, the area specification part 213B acquires the first initial sensing value stored in the memory 22 and the current first sensing value. Based on the current position and current posture of the camera 1 with respect to the initial position and initial posture of the camera 1, the current position and current posture being estimated based on the first initial sensing value and the current first sensing value, the area specification part 213B specifies the area in the image acquired this time, the area matching the initial capturable image, as the capturable area.

The area specification part 213B calculates the current position and current posture of the camera 1 relative to the initial position and initial posture of the camera 1 represented by the first initial sensing value, and specifies the capturable area based on calculation results. The area specification part 213B estimates the current capturing range of the camera 1 with respect to the initial capturable image from the initial position and initial posture of the camera 1 and the current position and current posture of the camera 1. The area specification part 213B specifies the area in the image acquired this time, the area matching the initial capturable image, from the current capturing range for the initial capturable image as the capturable area.

That is, from the first initial sensing value and the current first sensing value, the movement direction and movement distance of the camera 1 from the initial position and initial posture are calculated. Then, the current position and current posture of the camera 1 are estimated from the calculated movement direction and movement distance. The current capturing range of the camera 1 with respect to the initial capturable image is estimated from the estimated current position and current posture of the camera 1, and the area that matches the initial capturable image in the image acquired this time is specified as the capturable area.

The memory 22 stores the initial capturable image specified when the plurality of markers is first recognized. The memory 22 stores the first initial sensing value acquired when the plurality of markers is first recognized.

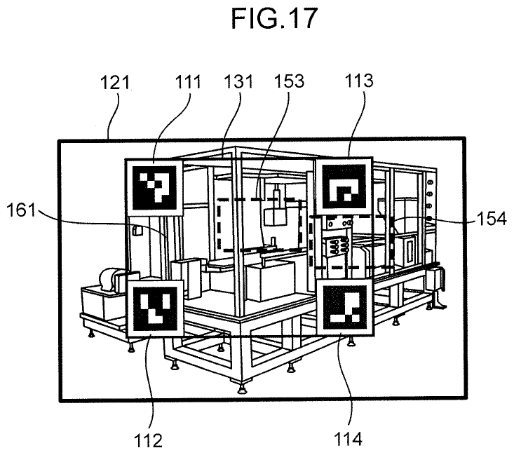

FIG. 17 is a view showing one example of an image 121 captured by the camera 1 when all the plurality of markers are first recognized in the present third embodiment. Note that in FIG. 17, the markers are illustrated larger than the actual markers for ease of understanding the description.

The image 121 includes all the four markers 111, 112, 113, and 114. The marker recognition part 212 recognizes the four markers 111, 112, 113, and 114 included in the image 121 acquired by the image acquisition part 211. When all the four markers 111, 112, 113, and 114 are recognized, the area specification part 213B specifies a capturable area 131 surrounded by the four recognized markers 111, 112, 113, and 114. When the four markers 111, 112, 113, and 114 are first recognized, the area specification part 213B stores in the memory 22 a capturable image 161 in the capturable area 131 in the image 121 as an initial capturable image 171, and stores in the memory 22 the first sensing value representing the position and posture of the camera 1 as the first initial sensing value.

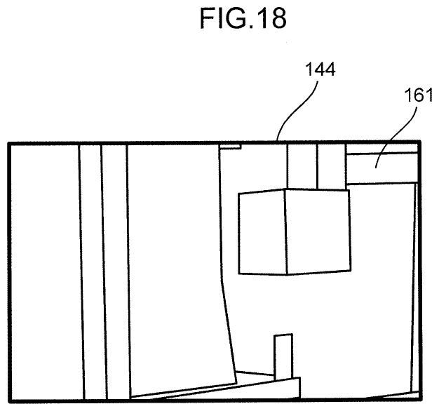

FIG. 18 is a view showing one example of a mask image 144 created when the camera 1 comes close to a support target device 101 from an initial position in the present third embodiment.

The capturing range at the initial position and initial posture of the camera 1 is the image 121 in FIG. 17. When the camera 1 comes close to the support target device 101 from the initial position, the capturing range of the camera 1 captured at the current position and current posture of the camera 1 changes to an area 153 in FIG. 17. The area specification part 213B estimates the current capturing range of the camera 1 with respect to the initial capturable image from the initial position and initial posture of the camera 1 and the current position and current posture of the camera 1.

The mask image creation part 214 creates the mask image 144 that masks the area outside the capturable area 131 in the image acquired this time. In the mask image 144 shown in FIG. 18, since the entire image acquired this time is the capturable area 131, the mask image 144 is entirely visible.

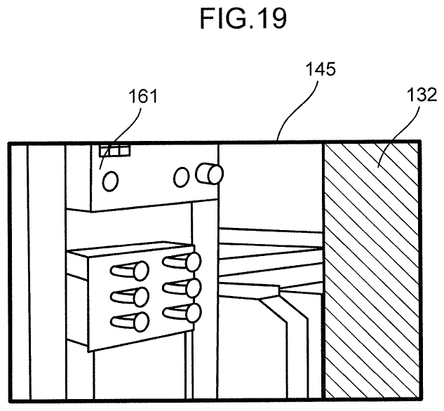

FIG. 19 is a view showing one example of a mask image 145 created when the camera 1 comes close to the support target device 101 from the initial position and the capturing range moves to the right in the present third embodiment.

The capturing range at the initial position and initial posture of the camera 1 is the image 121 in FIG. 17. When the camera 1 comes close to the support target device 101 from the initial position and the capturing range moves to the right, the capturing range of the camera 1 captured at the current position and current posture of the camera 1 changes to an area 154 in FIG. 17. The area specification part 213B estimates the current capturing range of the camera 1 with respect to the initial capturable image from the initial position and initial posture of the camera 1 and the current position and current posture of the camera 1.

The mask image creation part 214 creates the mask image 145 that masks the area 132 outside the capturable area 131 in the image acquired this time. The mask image creation part 214 performs the masking process on the area 132 outside the capturable area 131 in the image acquired this time. In the mask image 145 shown in FIG. 19, the capturable image 161 in the capturable area 131 is visible, whereas the area 132 other than the capturable area 131 is concealed.

Subsequently, the work support process by the image processing device 2B in the third embodiment of the present disclosure will be described.

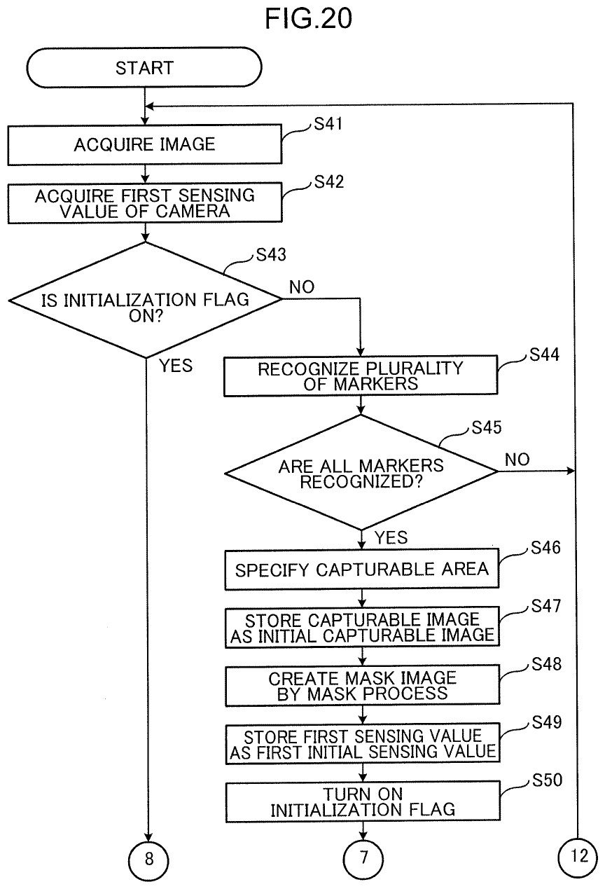

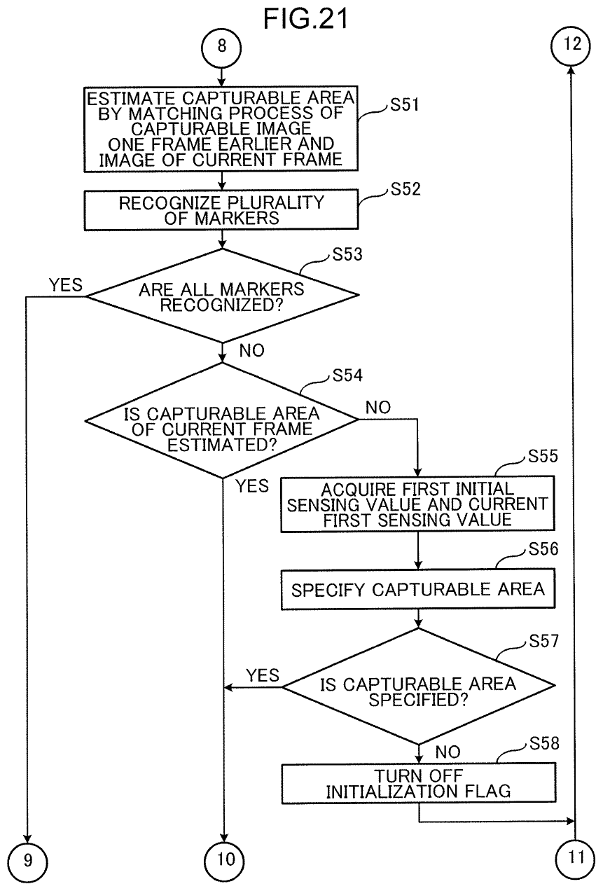

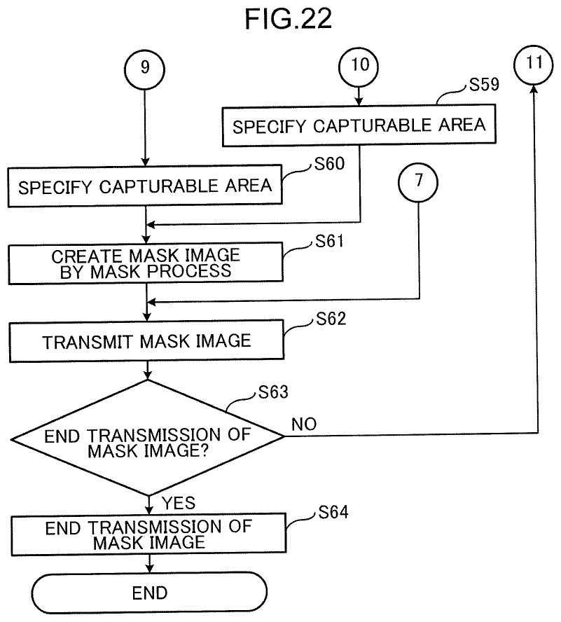

FIG. 20 is a first flowchart for describing the work support process by the image processing device 2B in the third embodiment of the present disclosure. FIG. 21 is a second flowchart for describing the work support process by the image processing device 2B in the third embodiment of the present disclosure. FIG. 22 is a third flowchart for describing the work support process by the image processing device 2B in the third embodiment of the present disclosure.

The processing in step S41 is identical to the processing in step S21 shown in FIG. 14, and thus description thereof will be omitted.

Next, in step S42, the sensing value acquisition part 217 acquires the first sensing value representing the position and posture of the camera 1. The sensing value acquisition part 217 acquires the first sensing value measured by the camera 1.

The processing in steps S43 to S48 is identical to the processing in steps S22 to S27 shown in FIG. 14, and thus description thereof will be omitted.

Next, in step S49, the area specification part 213B stores in the memory 22 the first sensing value representing the position and posture of the camera 1 when all the markers are first recognized as the first initial sensing value.

Next, in step S50, the area specification part 213B turns on the initialization flag stored in the memory 22. After the initialization flag is turned on, the process proceeds to step S62.

The processing in steps S51 to S54 is identical to the processing in steps S29 to S32 shown in FIGS. 14 and 15, and thus description thereof will be omitted.

Here, when it is determined that the capturable area of the current frame is estimated (YES in step S54), the process proceeds to step S59. The processing in step S59 is identical to the processing in step S33 shown in FIG. 15, and thus description thereof will be omitted.

On the other hand, when it is determined that the capturable area of the current frame is not estimated (NO in step S54), in step S55, the area specification part 213B acquires the first initial sensing value stored in the memory 22 and the current first sensing value acquired by the sensing value acquisition part 217.

Next, in step S56, based on the current position and current posture of the camera 1 with respect to the initial position and initial posture of the camera 1, the current position and current posture being estimated based on the first initial sensing value and the current first sensing value, the area specification part 213B specifies the area in the image acquired this time, the area matching the initial capturable image, as the capturable area.

Next, in step S57, the area specification part 213B determines whether the capturable area is specified by using the first initial sensing value and the current first sensing value.

Here, when it is determined that the capturable area is not specified (NO in step S57), in step S58, the area specification part 213B turns off the initialization flag stored in the memory 22. After the initialization flag is turned off, the process returns to step S41.

On the other hand, when it is determined that the capturable area is specified (YES in step S57), the process proceeds to step S59.

On the other hand, when it is determined that all the markers are recognized (YES in step S53), in step S60, the area specification part 213B specifies the capturable area surrounded by the plurality of markers recognized by the marker recognition part 212.

The processing in steps S61 to S64 is identical to the processing in steps S36 to S39 shown in FIG. 15, and thus description thereof will be omitted.

As in the second embodiment, for each frame, even if the matching process is performed on the capturable image in the capturable area one frame earlier and the image of the current frame, if light hits the support target device 101 or a shadow is generated, there is a risk that the matching process may face difficulties and the capturable area cannot be estimated.

In contrast, in the present third embodiment, since the capturable area is specified by using the first initial sensing value and the current first sensing value, the accuracy of specifying the capturable area can be improved.

Note that in the present third embodiment, if the camera 1 has a zoom function to enlarge or reduce a subject, the first sensing value may include information regarding zoom magnification. The zoom function may enlarge or reduce the subject optically, or may enlarge or reduce the subject by image processing.

In the present third embodiment, the capturable area is specified by using the first initial sensing value and the current first sensing value, but the present disclosure is not particularly limited to this example. When the capturable area is not specified based on the capturable area of the current frame estimated by the area estimation part 216, the area specification part 213B may acquire the first sensing value one frame earlier and the current first sensing value. Based on the current position and current posture of the camera 1 with respect to the position and posture of the camera 1 one frame earlier, the current position and current posture being estimated based on the first sensing value one frame earlier and the current first sensing value, the area specification part 213B may specify the area in the image acquired this time, the area matching the capturable image one frame earlier, as the capturable area.

In this case, after storing the first initial sensing value in the memory 22 when all the markers are first recognized, the area specification part 213B acquires the first sensing value representing the position and posture of the camera 1 for each frame, and stores the acquired first sensing value in the memory 22. As a result, the first initial sensing value stored in the memory 22 when all the markers are first recognized is updated for each frame. Based on the current position and current posture of the camera 1 with respect to the position and posture of the camera 1 one frame earlier, which are estimated based on the first sensing value one frame earlier and the current first sensing value, the area specification part 213B specifies the area in the image acquired this time, the area matching the capturable image one frame earlier, as the capturable area.

The area specification part 213B calculates the current position and current posture of the camera 1 relative to the position and posture of the camera 1 represented by the first sensing value one frame earlier, and specifies the capturable area based on calculation results. The area specification part 213B estimates the current capturing range with respect to the capturable image one frame earlier from the position and posture of the camera 1 one frame earlier and the current position and current posture of the camera 1. The area specification part 213B specifies the area in the image acquired this time, the area matching the capturable image one frame earlier from the current capturing range for the capturable image one frame earlier, as the capturable area.

That is, from the first sensing value one frame earlier and the current first sensing value, the movement direction and movement distance from the position and posture of the camera 1 one frame earlier are calculated. Then, the current position and current posture of the camera 1 are estimated from the calculated movement direction and movement distance. The current capturing range of the camera 1 with respect to the capturable image one frame earlier is estimated from the estimated current position and current posture of the camera 1, and the area in the image acquired this time, the area matching the capturable image one frame earlier, is specified as the capturable area.

In the present third embodiment, the image processing device 2A in the second embodiment includes the sensing value acquisition part 217 and the area specification part 213B, but the present disclosure is not particularly limited to this example. The image processing device 2 in the first embodiment may include the sensing value acquisition part 217 and the area specification part 213B. In this case, after step S6 of FIG. 11, the area specification part 213B stores in the memory 22 the first sensing value representing the position and posture of the camera 1 when all the markers are first recognized as the first initial sensing value. When it is determined that the capturable area is not specified by the matching process of the initial capturable image and the image acquired this time (NO in step S11 of FIG. 12), the area specification part 213B may perform the processing from step S55 to step S59 shown in FIG. 21.

In addition, the camera 1 may further include a second sensor that detects the distance from the camera 1 to an object for each pixel in the image. The second sensor is, for example, a depth sensor. The camera 1 may transmit, to the image processing device 2, the image along with a second sensing value representing the distance from the camera 1 to the object for each pixel in the image. When the plurality of markers is first recognized, the area specification part 213B may store in the memory 22 the capturable image in the capturable area in the image as the initial capturable image, and store in the memory 22 each distance from the camera 1 to the object for each pixel in the initial capturable image as the second initial sensing value. When the capturable area is not specified based on the capturable area of the current frame estimated by the area estimation part 216, the area specification part 213B may acquire the second initial sensing value and the second sensing value representing the distance from the camera 1 to the object for each pixel in the image acquired this time. Then, the area specification part 213B may specify, as the capturable area, the area where the second sensing value of the plurality of pixels in the image acquired this time is equal to or less than the longest distance of the second initial sensing value.

In the present third embodiment, the area specification part 213B may use the first sensing value to specify the capturable area, or may use the second sensing value to specify the capturable area. The area specification part 213B may use both the first sensing value and the second sensing value to specify the capturable area. In this case, the area specification part 213B may calculate the logical product of the capturable area specified using the first sensing value and the capturable area specified using the second sensing value.

Note that in each of the above embodiments, each constituent element may include dedicated hardware or may be implemented by execution of a software program suitable for each constituent element. Each constituent element may be implemented by a program execution part, such as a CPU or a processor, reading and executing a software program recorded in a recording medium such as a hard disk or a semiconductor memory. The program may be executed by another independent computer system by being recorded in a recording medium and transferred or by being transferred via a network.

Some or all functions of the device according to the embodiments of the present disclosure are implemented as large scale integration (LSI), which is typically an integrated circuit. These functions may be individually integrated into one chip, or may be integrated into one chip so as to include some or all functions. Circuit integration is not limited to LSI, and may be implemented by a dedicated circuit or a general-purpose processor. A field programmable gate array (FPGA), which can be programmed after manufacturing of LSI, or a reconfigurable processor in which connection and setting of circuit cells inside LSI can be reconfigured may be used.

Some or all functions of the device according to the embodiments of the present disclosure may be implemented by a processor such as a CPU executing a program.

All numbers used above are illustrated to specifically describe the present disclosure, and the present disclosure is not limited to the illustrated numbers.

The order in which steps shown in the above flowcharts are executed is for specifically describing the present disclosure, and may be any order other than the above order as long as a similar effect is obtained. Some of the above steps may be executed simultaneously (in parallel) with other steps.

The technology according to the present disclosure can output an image in which all areas other than the capturable area surrounded by the plurality of markers are masked, even if the plurality of markers is not recognized. Therefore, this technology is useful as a technology for masking areas other than the capturable area in an image.

1. An information processing method in a computer, the information processing method comprising:
acquiring an image captured by a camera;
recognizing a plurality of markers included in the image;
specifying a capturable area surrounded by the plurality of recognized markers when the plurality of markers is recognized, and specifying, as the capturable area, an area in the image acquired this time, the area matching a capturable image in the capturable area previously specified when the plurality of markers is not recognized;
creating a mask image that masks an area outside the capturable area in the image; and
outputting the mask image.

2. The information processing method according to claim 1, wherein creating the mask image includes creating the mask image with all areas in the image masked when the capturable area is not specified.

3. The information processing method according to claim 1, wherein when the plurality of markers is not recognized, specifying the capturable area includes: comparing the image acquired this time with the capturable image in the capturable area specified previously; and specifying the area that matches the capturable image in the image as the capturable area.

4. The information processing method according to claim 3, further comprising storing, in a memory, the capturable image in the capturable area in the image as an initial capturable image when the plurality of markers is first recognized,
wherein specifying the capturable area includes: comparing the initial capturable image with the image acquired this time; and specifying the area that matches the initial capturable image in the image as the capturable area when the plurality of markers is not recognized.

5. The information processing method according to claim 4, further comprising:
storing a first sensing value representing a position and posture of the camera in the memory as a first initial sensing value when the plurality of markers is first recognized;
acquiring the first initial sensing value and the current first sensing value when the capturable area is not specified; and
specifying, as the capturable area, an area in the image acquired this time, the area matching the initial capturable image, based on a current position and current posture of the camera with respect to an initial position and initial posture of the camera, the current position and current posture being estimated based on the first initial sensing value and the current first sensing value.

6. The information processing method according to claim 3, wherein specifying the capturable area includes specifying, as the capturable area, an area in the image acquired this time, the area matching the capturable image in the capturable area specified one frame earlier when the plurality of markers is not recognized.

7. The information processing method according to claim 6, further comprising:
comparing the capturable image in the capturable area estimated one frame earlier and stored in a memory with the image of a current frame acquired this time, and estimating an area that matches the capturable image in the image as the capturable area of the current frame;
storing the capturable image in the estimated capturable area of the current frame in the memory; and
specifying the capturable area includes specifying the estimated capturable area of the current frame as the capturable area when the plurality of markers is not recognized.

8. The information processing method according to claim 7, further comprising:
acquiring a first sensing value representing a position and posture of the camera for each frame, and storing the acquired first sensing value in the memory;
acquiring the first sensing value one frame earlier and the current first sensing value when the capturable area is not specified; and
specifying an area in the image acquired this time, the area matching the capturable image one frame earlier, as the capturable area based on a current position and current posture of the camera with respect to the position and posture of the camera one frame earlier, the current position and current posture being estimated based on the first sensing value one frame earlier and the current first sensing value.

9. The information processing method according to claim 1, further comprising:
storing, in a memory, the capturable image in the capturable area in the image of an initial frame as an initial capturable image when the plurality of markers is first recognized;
comparing the image one frame earlier with the image of a current frame, and calculating an amount of change between a capturing range of the image one frame earlier and a capturing range of the image of the current frame for each frame;
calculating a cumulative value of the amount of change from the initial frame to the current frame; and
specifying the capturable area includes specifying the capturable area of the current frame based on the initial capturable area and the cumulative value when the plurality of markers is not recognized.

10. The information processing method according to claim 1, further comprising:
storing, in a memory, the capturable image in the capturable area in the image as an initial capturable image when the plurality of markers is first recognized;
storing, in the memory, each distance from the camera to an object for each pixel in the initial capturable image as a second initial sensing value when the plurality of markers is first recognized;
acquiring the second initial sensing value and a second sensing value representing the distance from the camera to the object for each pixel in the image acquired this time when the capturable area is not specified; and
specifying, as the capturable area, an area where the second sensing value of the plurality of pixels in the image acquired this time is equal to or less than a longest distance of the second initial sensing value.

11. An information processing device comprising:
an acquisition part that acquires an image captured by a camera;
a recognition part that recognizes a plurality of markers included in the image;
a specification part that specifies a capturable area surrounded by the plurality of recognized markers when the plurality of markers is recognized, and specifies, as the capturable area, an area in the image acquired this time, the area matching a capturable image in the capturable area previously specified when the plurality of markers is not recognized;
a creation part that creates a mask image that masks an area outside the capturable area in the image; and
an output part that outputs the mask image.

12. A non-transitory computer readable recording medium storing an information processing program for causing a computer to execute functions of:
acquiring an image captured by a camera;
recognizing a plurality of markers included in the image;
specifying a capturable area surrounded by the plurality of recognized markers when the plurality of markers is recognized, and specifying, as the capturable area, an area in the image acquired this time, the area matching a capturable image in the capturable area previously specified when the plurality of markers is not recognized;
creating a mask image that masks an area outside the capturable area in the image; and
outputting the mask image.
